(19) United States
(12) Patent Application Publication
(10) Pub. No.: US 2015/0097028 A1
(43) Pub. Date: Apr. 9, 2015

(54) SYSTEM AND METHOD FOR MOBILE PROMOTIONS PROCESSING

(71) Applicant: Outsite Networks, Inc., Norfolk, VA (US)

(72) Inventors: Anton Bakker, Norfolk, VA (US); Marc L. Allen, Virginia Beach, VA (US)

(73) Assignee: Outsite Networks, Inc., Norfolk, VA (US)

(21) Appl. No.: 14/049,691

(22) Filed: Oct. 9, 2013

(51) Int. Cl. G06Q 30/02; G06Q 20/34

(52) U.S. Cl. CPC G06Q 30/0238; G06Q 20/351
USPC 235/379; 235/380; 235/383

(57) ABSTRACT

A system, method and computer program product for promotions processing, including a point-of-sale (POS) device having a barcode scanner interface device; a user device having a wireless communications interface device; and a barcode inserter device having a wireless communications interface device. The barcode inserter device is configured to receive via the communications interface device of the barcode inserter device a barcode transmitted from the user device via the communications interface of the user device. The barcode inserter device is configured insert the received barcode into a transaction at the POS device via the barcode scanner interface device of the POS device.

### BACKGROUND OF THE INVENTION

1. Field of the Invention

The present invention generally relates to systems and methods for processing promotions, and more particularly to a system and method for processing promotions, including barcodes, and the like, with mobile phones, and the like.

2. Discussion of the Background

Barcode processing systems and methods have been employed for numerous years in stores and online for providing promotions, purchasing incentives, and the like. However, the present barcode processing systems and methods typically are only configured for processing printed barcodes and encounter problems when accepting barcodes as provided by mobile phones, and the like. Present barcode processing systems most often include laser-based scanners, which are unable to process barcodes presented on a screen, such as can be found on mobile phones, and the like. Recent advances are seeing the use of optical scanners, but those often have issues due to typical screen protective devices, which distort the image as seen by an optical scanner. Additionally, as there is no physical object with the printed barcode to be stored in a point-of-sale (POS), there is no record that a barcode was accepted, resulting in fraudulent activity, and the like.

### SUMMARY OF THE INVENTION

Therefore, there is a need for a method and system that addresses the above and other problems with conventional systems and methods for processing mobile barcodes. The above and other problems are addressed by the illustrative embodiments of the present invention, which provide a novel system and method including suitable mechanisms provided in a mobile phone, and the like, to allow inserting of barcodes (e.g., Universal Product Code (UPC)-A, UPC-E, European Article Number (EAN), Quick Response (QR) code, GS1 code, Code 128, Code 39, etc.) associated with a UPC via a UPC inserter device into devices, such as cash registers, printers, and the like, at a point-of-sale (e.g., grocery store, convenience store, other store, theatre, gas station, car wash, etc.), for example, by employing Bluetooth Low Energy (BLE) devices (e.g., iBeacon, etc.) or other suitable devices (e.g., Near Field communication (NFC), 802.11, ad-hoc and/or other wireless networking devices, encoded audio and/or optical transmission devices, etc.) with the mobile phone and at the POS.

Accordingly, in illustrative aspects of the present invention there is provided a system, method and computer program product for promotions processing, including a point-of-sale (POS) device having a barcode scanner interface device; a user device having a wireless communications interface device; and a barcode inserter device having a wireless communications interface device. The barcode inserter device is configured to receive via the communications interface device of the barcode inserter device a barcode transmitted from the user device via the communications interface of the user device. The barcode inserter device is configured insert the received barcode into a transaction at the POS device via the barcode scanner interface device of the POS device.

The barcode references barcode information stored in the barcode inserter device or barcode information determined by an outside agency that provides the barcode information to the user device.

The barcode inserter device is configured to convert a monetary amount into the barcode sent to the POS device, and the monetary amount is associated with available credit on at least one of a payment card, credit card, debit card, bank account, loyalty card, and electronic account.

The POS device has an available port for a scanner device that is used directly by the barcode inserter device.

The POS device includes a communications interface device for directly communicating with the communications interface device of the user device for directly accepting the barcode from the user device.

The communications interface device of the user device, the barcode inserter device, and the POS device include at least one of a bluetooth low energy (BLE) interface device, an 802.11 wireless interface device, a near field communications (NFC) interface device, an encoded audio interface device, and an optical transmission interface device.

The barcode includes data formatted for the POS device, including a universal product code (UPC) data, UPC-A data, UPC-E data, European Article Number (EAN) data, Quick Response (QR) code data, GS1 code data, Code 128 data, and Code 39 data.

The user device includes a mobile phone device, a portable device with communications capability, including a computer tablet device, and a personal data device.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 shows an illustrative system for mobile barcode processing using a mobile phone and Universal Product Code (UPC) inserter device using Bluetooth Low Energy (BLE) devices; and

FIG. 2 shows an illustrative flow chart corresponding to the mobile barcode processing system of FIG. 1.

### DETAILED DESCRIPTION OF THE PREFERRED EMBODIMENTS

The present invention includes recognition of problems associated with accepting barcodes associated with mobile phones, and the like, by barcode-ready systems and methods configured for processing barcodes. In addition, besides mobile barcode scanning issues, such barcode scanning systems and methods do not adequately address providing of a point-of-sale (POS) record for a scanned mobile phone barcode, issues related to fraud with respect to claiming of mobile phone barcodes, issues related to redemption tracking of scanned mobile phone barcodes, issues related to reimbursement of claimed mobile phone offers, issues related to communications interfacing with mobile phones, issues related to being configured to only work with paper coupons (e.g., as in grocery stores, etc.), and the like.

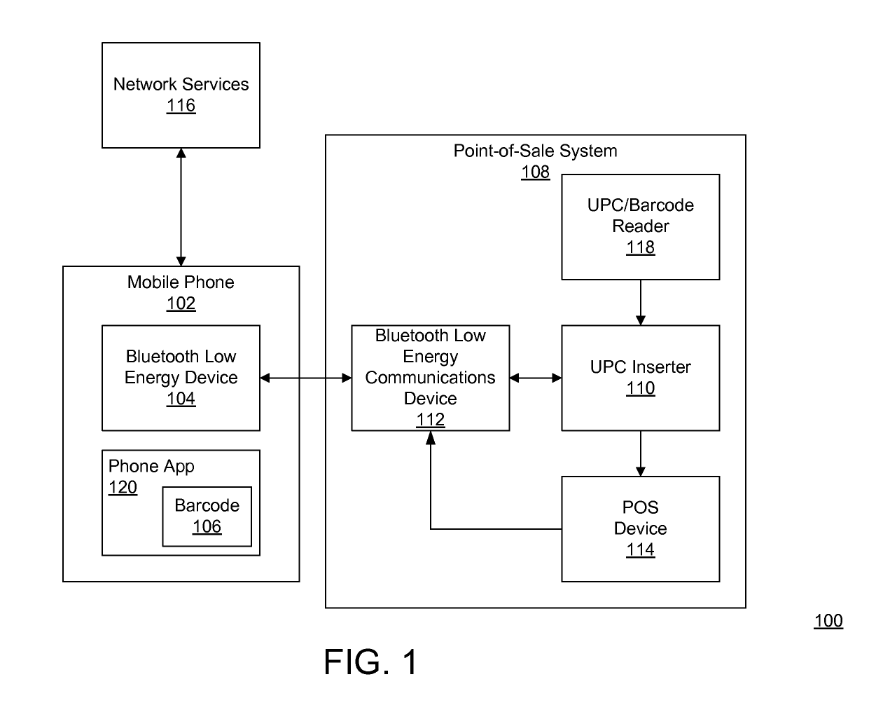

Referring now to the drawings, wherein like reference numerals designate identical or corresponding parts throughout the several views, and more particularly to FIG. 1 thereof, there is shown an illustrative system 100 for mobile barcode processing using a mobile phone device, and the like. In FIG. 1, the system 100 includes an illustrative mobile phone 102 coupled, for example, using Bluetooth Low Energy (BLE) communications 104, and the like, to a BLE device reader/writer device 112 (e.g., iBeacon, etc.). The mobile phone 120 includes an application 120 (e.g., custom promotional application (app), web browser, etc.) that receives a selected or randomly applicable barcode or barcode reference from Network Services 116 (e.g., web sites, etc.). The BLE communications device 112 sends the received information to a Barcode/Universal Product Code (UPC) inserter device 110 (e.g., including suitable processor, memory, software, etc.). The UPC inserter device 110 can be coupled between a POS device 114 (e.g., cash register, printer, etc.) and a UPC/Barcode reader device 114 of a point-of-sale (POS) system 108 (e.g., located in a grocery store, convenience store, other store, theatre, gas station, car wash, etc.) for generating a suitable information that can be used for processing by the POS device 114 and/or the POS system 108.

Accordingly, the Barcode 106 is selected or associated with the mobile phone 102 and BLE device 104. The mobile phone 102 being equipped with the BLE device 104 is configured to allow the Barcode 106 to be actively, passively, and the like, selected or associated for the mobile phone 102 or user thereof. For example, in an active mode, the user can choose to select the mobile Barcode 106 on the mobile phone 102. In a passive mode, the user may have earned, won, or the like, the mobile Barcode 106. The Barcode 106 is linked to the BLE device 104 and associated with the mobile phone 102 and/or user thereof. The BLE device 104, upon selection and/or acknowledgement of the user, transmits suitable information regarding the Barcode 106 to the BLE device 112. The information regarding the Barcode 106 can optionally be validated by the POS system 108 and such validation be transmitted by mobile phone 102 coupled to a suitable server system 116 over a suitable communications network (e.g., LAN, WAN, the Internet, etc.). The UPC inserter device 110 receives the Barcode 106 information and sends the information to the POS device 114 for processing.

When a UPC/Barcode reader 118 is being employed, the UPC inserter device 110 passes the information received from the UPC/Barcode reader 118 to the POS device 114 for processing. In further illustrative embodiments, the BLE device 104 can be included with the mobile phone 102 when purchased, or added later via a connected module, and the like.

Once the POS system 108 has accepted the UPC into the transaction and actively (e.g., via direct communications) or passively (e.g., via presence of UPC in a monitored receipt, etc.) informed BLE device 112, the BLE device 112 can transmit that fact to the BLE device 104 in the mobile phone 102. The mobile phone 102 passes the acknowledgement to the Application 120 which then can clear the coupon from internal storage and/or communicate such acknowledgement to Network Services 116 (e.g., web services, coupon clearing house, etc.).

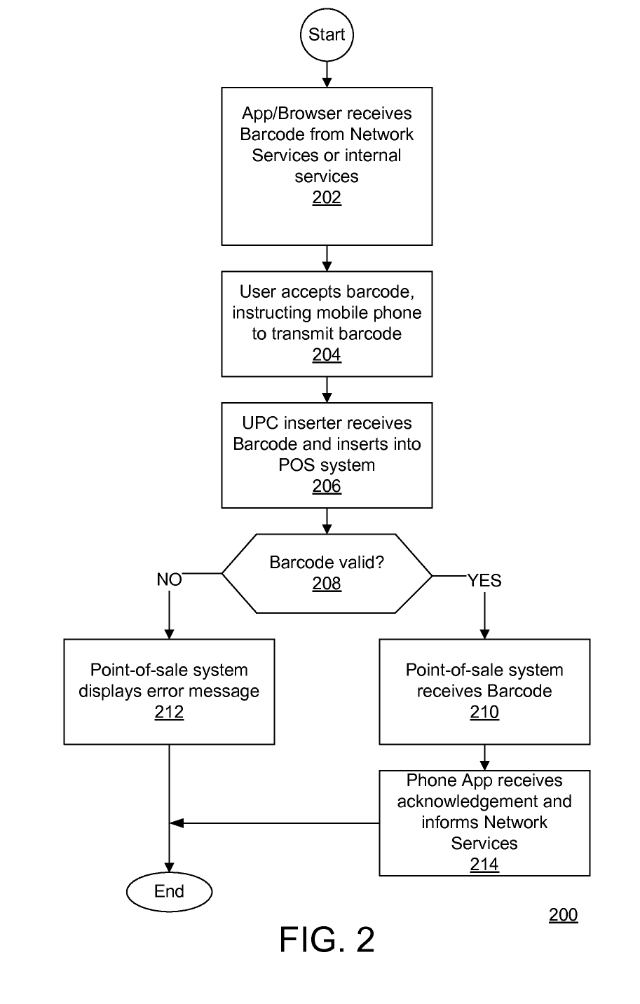

FIG. 2 illustrates an illustrative flow chart 200 corresponding to the promotions processing system 100 of FIG. 1. In FIG. 2, at step 202, the Barcode 106 is received from internal storage and/or Network Services 116 on the mobile phone 102, as previously described. At step 204, the user selects or otherwise accepts the Barcode 106 at the mobile phone 102 causing the mobile phone 102 to transmit the UPC using BLE device 104 to the POS system 108 via BLE device 112. At step 206, the Barcode 106 information is received by the UPC inserter device 110 from the BLE device 112, as previously described. At step 208, the POS system 206 can validate the Barcode 106, as previously described. At step 210, the POS system 108 allows the POS device 114 to process the Barcode 106 information, as previously described. At step 214, acknowledgement of the coupon is routed back to Network Services 116 via BLE device 112 to BLE device 104 and the Application 120 on mobile phone 102, completing the process. Otherwise, as determined at step 208, if the POS system 206 cannot validate the Barcode 106, at step 212, the POS system 108 does not allow the POS device 114 to process the Barcode 106 information, and displays a suitable message, as previously described, completing the process.

In further illustrative embodiments, instead of the mobile phone 102, any other suitable devices can be employed, for example, including portable devices with communications capability, including tablets (e.g., iPad, Nexus 7, etc.), personal data devices (e.g., iPod, etc.), and the like, as will be appreciated by those of ordinary skill in the relevant art(s).

In further illustrative embodiments, instead of the BLE interface devices, any other suitable devices can be employed, for example, including Near Field Communication (NFC), 802.11, ad-hoc and/or other wireless networking devices, encoded audio and/or optical transmission devices, and the like, as will be appreciated by those of ordinary skill in the relevant art(s).

In further illustrative embodiments, the employed barcode references barcode information stored in the barcode inserter device 110 or barcode information determined by an outside agency that provides the barcode information to the user device 102, as will be appreciated by those of ordinary skill in the relevant art(s).

In further illustrative embodiments, the barcode inserter device 110 can be configured to convert a promotion and/or a monetary amount into the barcode sent to the POS device 114, and the monetary amount is associated with available credit on a payment card or other suitable account, such as a credit card, debit card, bank account, loyalty card, electronic account, and the like, as will be appreciated by those of ordinary skill in the relevant art(s).

In further illustrative embodiments, the POS device 114 can include an available port for a scanner device that is used directly by the barcode inserter device 110, as will be appreciated by those of ordinary skill in the relevant art(s).

In further illustrative embodiments, the POS device 114 can include a communications interface device for directly communicating with the communications interface device 104 of the user device 102 for directly accepting the barcode from the user device 102, as will be appreciated by those of ordinary skill in the relevant art(s).

The above-described devices and subsystems of the illustrative embodiments of FIGS. 1-2 can include, for example, any suitable servers, workstations, PCs, laptop computers, PDAs, Internet appliances, handheld devices, cellular telephones, wireless devices, other devices, and the like, capable of performing the processes of the illustrative embodiments of FIGS. 1-2. The devices and subsystems of the illustrative embodiments of FIGS. 1-2 can communicate with each other using any suitable protocol and can be implemented using one or more programmed computer systems or devices.

One or more interface mechanisms can be used with the illustrative embodiments of FIGS. 1-2, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, a combination thereof, and the like. Accordingly, the devices and subsystems of the illustrative embodiments can be implemented on the World Wide Web.

It is to be understood that the devices and subsystems of the illustrative embodiments of FIGS. 1-2 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1-2 can be implemented via one or more programmed computer systems or devices.

To implement such variations as well as other variations, a single computer system can be programmed to perform the special purpose functions of one or more of the devices and subsystems of the illustrative embodiments of FIGS. 1-2. On the other hand, two or more programmed computer systems or devices can be substituted for any one of the devices and subsystems of the illustrative embodiments of FIGS. 1-2. Accordingly, principles and advantages of distributed processing, such as redundancy, replication, and the like, also can be implemented, as desired, to increase the robustness and performance the devices and subsystems of the illustrative embodiments of FIGS. 1-2.

The devices and subsystems of the illustrative embodiments of FIGS. 1-2 can store information relating to various processes described herein. This information can be stored in one or more memories, such as a hard disk, optical disk, magneto-optical disk, RAM, and the like, of the devices and subsystems of the illustrative embodiments of FIGS. 1-2. One or more databases of the devices and subsystems of the illustrative embodiments of FIGS. 1-2 can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments of FIGS. 1-2 can include appropriate data structures for storing data collected and/or generated by the processes of the devices and subsystems of the illustrative embodiments of FIGS. 1-2 in one or more databases thereof.

All or a portion of the devices and subsystems of the illustrative embodiments of FIGS. 1-2 can be conveniently implemented using one or more general purpose computer systems, microprocessors, digital signal processors, micro-controllers, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1-2 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments of FIGS. 1-2, for driving the devices and subsystems of the illustrative embodiments of FIGS. 1-2, for enabling the devices and subsystems of the illustrative embodiments of FIGS. 1-2 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments of FIGS. 1-2. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments of FIGS. 1-2 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of the appended claims.

What is claimed is:

1. A system for promotions processing, the system comprising:
a point-of-sale (POS) device having a barcode scanner interface device;
a user device having a wireless communications interface device; and
a barcode inserter device having a wireless communications interface device,
wherein the barcode inserter device is configured to receive via the communications interface device of the barcode inserter device a barcode transmitted from the user device via the communications interface of the user device, and
the barcode inserter device is configured insert the received barcode into a transaction at the POS device via the barcode scanner interface device of the POS device.

2. The system of claim 1, wherein the barcode references barcode information stored in the barcode inserter device or barcode information determined by an outside agency that provides the barcode information to the user device.

3. The system of claim 1, wherein the barcode inserter device is configured to convert a monetary amount into the barcode sent to the POS device, and the monetary amount is associated with available credit on at least one of a payment card, credit card, debit card, bank account, loyalty card, and electronic account.

4. The system of claim 1, wherein the POS device has an available port for a scanner device that is used directly by the barcode inserter device.

5. The system of claim 1, wherein the POS device includes a communications interface device for directly communicating with the communications interface device of the user device for directly accepting the barcode from the user device.

6. The system of claim 5, wherein the communications interface device of the user device, the barcode inserter device, and the POS device include at least one of a bluetooth low energy (BLE) interface device, an 802.11 wireless interface device, a near field communications (NFC) interface device, an encoded audio interface device, and an optical transmission interface device,
the barcode includes data formatted for the POS device, including a universal product code (UPC) data, UPC-A data, UPC-E data, European Article Number (EAN) data, Quick Response (QR) code data, GS1 code data, Code 128 data, and Code 39 data, and
the user device includes a mobile phone device, a portable device with communications capability, including a computer tablet device, and a personal data device.

7. A method for use in a system for promotions processing, the method comprising:
providing a point-of-sale (POS) device having a barcode scanner interface device;
providing a user device having a wireless communications interface device;
providing a barcode inserter device having a wireless communications interface device;
receiving via the barcode inserter device via the communications interface device of the barcode inserter device a barcode transmitted from the user device via the communications interface of the user device; and
inserting via the barcode inserter device the received barcode into a transaction at the POS device via the barcode scanner interface device of the POS device.

8. The method of claim 7, wherein the barcode references barcode information stored in the barcode inserter device or barcode information determined by an outside agency that provides the barcode information to the user device.

9. The method of claim 7, wherein the barcode inserter device is configured to convert a monetary amount into the barcode sent to the POS device, and the monetary amount is associated with available credit on at least one of a payment card, credit card, debit card, bank account, loyalty card, and electronic account.

10. The method of claim 7, wherein the POS device has an available port for a scanner device that is used directly by the barcode inserter device.

11. The method of claim 7, wherein the POS device includes a communications interface device for directly communicating with the communications interface device of the user device for directly accepting the barcode from the user device.

12. The method of claim 11, wherein the communications interface device of the user device, the barcode inserter device, and the POS device include at least one of a bluetooth low energy (BLE) interface device, an 802.11 wireless interface device, a near field communications (NFC) interface device, an encoded audio interface device, and an optical transmission interface device,
the barcode includes data formatted for the POS device, including a universal product code (UPC) data, UPC-A data, UPC-E data, European Article Number (EAN) data, Quick Response (QR) code data, GS1 code data, Code 128 data, and Code 39 data, and
the user device includes a mobile phone device, a portable device with communications capability, including a computer tablet device, and a personal data device.

13. A computer program product for promotions processing including one or more computer readable instructions embedded on tangible, non-transitory computer readable medium and configured to cause one or more computer processors to perform the steps of:
providing a point-of-sale (POS) device having a barcode scanner interface device;
providing a user device having a wireless communications interface device;
providing a barcode inserter device having a wireless communications interface device;
receiving via the barcode inserter device via the communications interface device of the barcode inserter device a barcode transmitted from the user device via the communications interface of the user device; and
inserting via the barcode inserter device the received barcode into a transaction at the POS device via the barcode scanner interface device of the POS device.

14. The computer program product of claim 13, wherein the barcode references barcode information stored in the barcode inserter device or barcode information determined by an outside agency that provides the barcode information to the user device.

15. The computer program product of claim 13, wherein the barcode inserter device is configured to convert a monetary amount into the barcode sent to the POS device, and the monetary amount is associated with available credit on at least one of a payment card, credit card, debit card, bank account, loyalty card, and electronic account.

16. The computer program product of claim 13, wherein the POS device has an available port for a scanner device that is used directly by the barcode inserter device.

17. The computer program product of claim 16, wherein the POS device includes a communications interface device for directly communicating with the communications interface device of the user device for directly accepting the barcode from the user device.

18. The computer program product of claim 13, wherein the communications interface device of the user device, the barcode inserter device, and the POS device include at least one of a bluetooth low energy (BLE) interface device, an 802.11 wireless interface device, a near field communications (NFC) interface device, an encoded audio interface device, and an optical transmission interface device,
the barcode includes data formatted for the POS device, including a universal product code (UPC) data, UPC-A data, UPC-E data, European Article Number (EAN) data, Quick Response (QR) code data, GS1 code data, Code 128 data, and Code 39 data, and
the user device includes a mobile phone device, a portable device with communications capability, including a computer tablet device, and a personal data device.
